(19) United States
(12) Patent Application Publication
(10) Pub. No.: US 2020/0026291 A1
(43) Pub. Date: Jan. 23, 2020

(54) METHOD AND APPARATUS FOR DELIVERING GOODS IN AUTONOMOUS DRIVING SYSTEM

(71) Applicant: LG Electronics Inc., Seoul (KR)

(72) Inventor: Cheolseung KIM, Seoul (KR)

(21) Appl. No.: 16/588,712

(22) Filed: Sep. 30, 2019

(30) Foreign Application Priority Data
Aug. 15, 2019 (KR) 10-2019-0099975

(51) Int. Cl. G05D 1/00; G05D 1/02; G06Q 10/08

(52) U.S. Cl. CPC G05D 1/0088; G05D 2201/0213; G06Q 10/08355; G05D 1/0212

(57) ABSTRACT

In a method for delivering goods by a server in an autonomous driving system, a vehicle can deliver goods through steps of: receiving information on a target vehicle from the target vehicle; transmitting a travel request message to the target vehicle on the basis of the information on the target vehicle; receiving, from a delivery vehicle, a goods delivery request message for delivering goods to the target vehicle; determining a merging point indicating a point at which the goods will be delivered and a merging time indicating a time at which the delivery vehicle will meet the target vehicle at the merging point; and transmitting information on the goods, the merging point and the merging time to the target vehicle and the delivery vehicle.

### CROSS-REFERENCE TO RELATED APPLICATION

This application claims the benefit of Korean Patent Application No. 10-2019-0099975 filed on Aug. 15, 2019. The contents of this application are hereby incorporated by reference in its entirety.

### BACKGROUND OF THE INVENTION

### Field of the Invention

The present disclosure relates to an autonomous driving system and, more particularly, to delivering goods while vehicles are traveling.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

An object of the present disclosure is to provide a method for delivering goods to a vehicle which is traveling in an autonomous driving system.

Further, an object of the present disclosure is to provide a method for determining a merging point of vehicles to deliver goods to a vehicle which is traveling.

It will be appreciated by persons skilled in the art that the objects that could be achieved with the present disclosure are not limited to what has been particularly described hereinabove and the above and other objects that the present disclosure could achieve will be more clearly understood from the following detailed description.

In an aspect of the present disclosure, a method for delivering goods by a server in an autonomous driving system, the method may include: receiving information on a target vehicle from the target vehicle; transmitting a travel request message to the target vehicle on the basis of the information on the target vehicle; receiving, from a delivery vehicle, a goods delivery request message for delivering goods to the target vehicle; determining a merging point indicating a point at which the goods will be delivered and a merging time indicating a time at which the delivery vehicle will meet the target vehicle at the merging point; and transmitting information on the goods, the merging point and the merging time to the target vehicle and the delivery vehicle, wherein goods delivery may be performed during traveling of the target vehicle and the delivery vehicle, the travel request message may include a travel route of the target vehicle, and the merging point may indicate a point on the travel route which satisfies a road environment in which goods delivery can be performed.

Further, the method may further include transmitting, to a mobile edge computing (MEC) server, information on the target vehicle and the delivery vehicle and information on the merging point and the merging time, wherein the MEC server may be associated with the merging point.

Further, the MEC server may generate a control message for causing the target vehicle and the delivery vehicle to perform goods delivery.

Further, the information on the target vehicle may include specifications of the target vehicle, the number of carrying cargo boxes, positional information of a destination, and a time of arrival at the destination.

Further, the method may further include determining the target vehicle on the basis of the information on the target vehicle, wherein the server may receive information on one or more target vehicles and the delivery vehicle can deliver the goods to the target vehicle within the time or arrival.

Further, the target vehicle and the delivery vehicle may receive the control message for performing goods delivery through the MEC server.

Further, the information on the goods may include IDs and the number of cargo boxes which are targets of goods delivery.

Further, each of the target vehicle and the delivery vehicle may include a cargo compartment for carrying the cargo boxes, the cargo compartment may include a conveyor belt for moving the cargo boxes and a door, and the door may connect the target vehicle to the delivery vehicle such that the cargo boxes are delivered.

Further, the target vehicle and the delivery vehicle may change positions of the cargo boxes to perform goods delivery through the conveyor belt on the basis of the information on the goods.

Further, the cargo compartment may include one or more decks for carrying the cargo boxes and a vertical transfer apparatus for moving the cargo boxes to the decks, and positions of the cargo boxes can be changed through the vertical transfer apparatus to perform goods delivery.

In another aspect of the present disclosure, a first vehicle for delivering goods in an autonomous driving system may include: a control device for controlling the vehicle; and a cargo compartment for carrying cargo boxes, wherein the cargo compartment may include a door and a lower conveyor belt for moving the cargo boxes, and the door may include a door conveyor belt for delivering the cargo boxes from the first vehicle to a second vehicle or receiving cargo boxes from the second vehicle during traveling.

Further, the lower conveyor belt may include a rotary motor for rotating the lower conveyor belt and change a movement direction of the cargo boxes.

Further, the cargo compartment may include one or more decks for carrying the cargo boxes and a vertical transfer apparatus for moving the cargo boxes to the decks, and the cargo boxes may be vertically moved through the vertical transfer apparatus.

Further, the control device may receive positional information on a merging point indicating a point for goods delivery from a server, and goods delivery may be performed at the merging point.

Further, the control device may receive a control signal for performing goods delivery at the merging point from a mobile edge computing (MEC) server and control the first vehicle using the control signal, and the MEC server may be associated with the merging point.

In another aspect of the present disclosure, a server performing a method for delivering goods in an autonomous driving system may include: a communication module; a memory; and a processor, wherein the processor may receive information on a target vehicle from the target vehicle through the communication module, transmit a travel request message to the target vehicle on the basis of the information on the target vehicle, receive, from a delivery vehicle, a goods delivery request message for delivering goods to the target vehicle, determine a merging point indicating a point at which the goods will be delivered and a merging time indicating a time at which the delivery vehicle will meet the target vehicle at the merging point and transmit information on the goods, the merging point and the merging time to the target vehicle and the delivery vehicle, wherein goods delivery may be performed during traveling of the target vehicle and the delivery vehicle, the travel request message may include a travel route of the target vehicle, and the merging point may indicate a point on the travel route which satisfies a road environment in which goods delivery can be performed.

According to an embodiment of the present disclosure, it is possible to deliver goods to a vehicle which is traveling in an autonomous driving system.

Further, according to an embodiment of the present disclosure, it is possible to determine merging point of vehicles to deliver goods to a vehicle which is traveling.

It will be appreciated by persons skilled in the art that the effects that could be achieved with the present disclosure are not limited to what has been particularly described hereinabove and the above and other effects that the present disclosure could achieve will be more clearly understood from the following detailed description.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram illustrating the interior of a vehicle according to an embodiment of the present disclosure.

FIG. 10 is a block diagram referred to in description of a cabin system for a vehicle according to an embodiment of the present disclosure.

FIG. 11 is a diagram referred to in description of a usage scenario of a user according to an embodiment of the present disclosure.

FIG. 12 illustrates an architecture of a mobile edge computing (MEC) server to which the present disclosure is applicable.

FIG. 13 illustrates an embodiment to which the present disclosure is applicable.

FIG. 14 illustrates an embodiment to which the present disclosure is applicable.

FIG. 15 is a diagram illustrating configurations of conveyor belts to which the present disclosure is applicable.

FIG. 16 is a diagram illustrating a configuration of a cargo box to which the present disclosure is applicable.

FIG. 17 is a diagram illustrating a configuration of a vertical transfer apparatus to which the present disclosure is applicable.

FIG. 18 illustrates an embodiment to which the present disclosure is applicable.

FIG. 19 illustrates the inside of a cargo compartment to which the present disclosure is applicable.

FIG. 20 illustrates an embodiment to which the present disclosure is applicable.

FIG. 21 illustrates an embodiment of a cloud server to which the present disclosure is applicable.

FIG. 22 is a diagram illustrating a configuration of a server to which the present disclosure is applied.

The accompanying drawings, which are included to provide a further understanding of the invention and are incorporated in and constitute a part of this specification, illustrate embodiments of the invention and together with the description serve to explain the principles of the invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

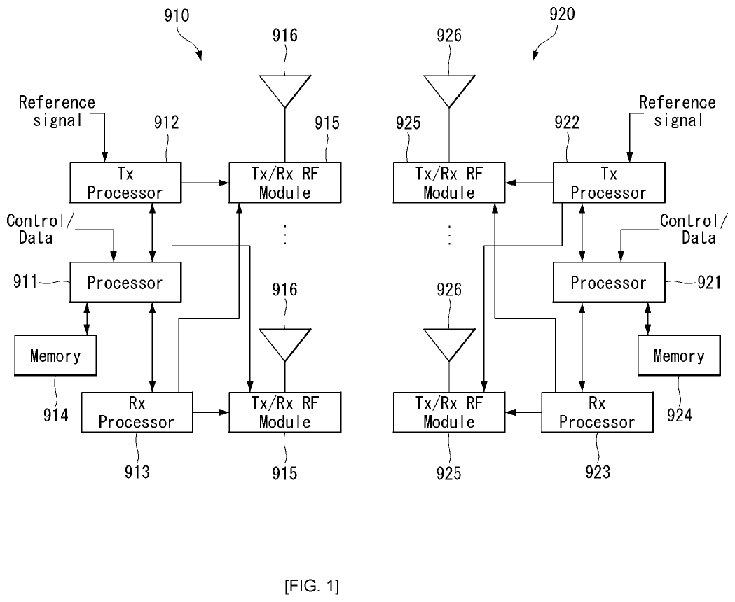

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

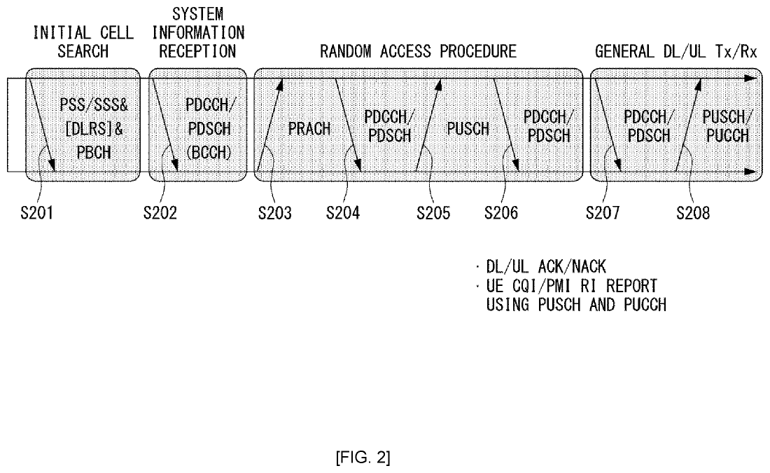

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemlnformationBlockl) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-lndex-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management’ from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionlnDCI by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic operation between autonomous vehicles using 5G communication

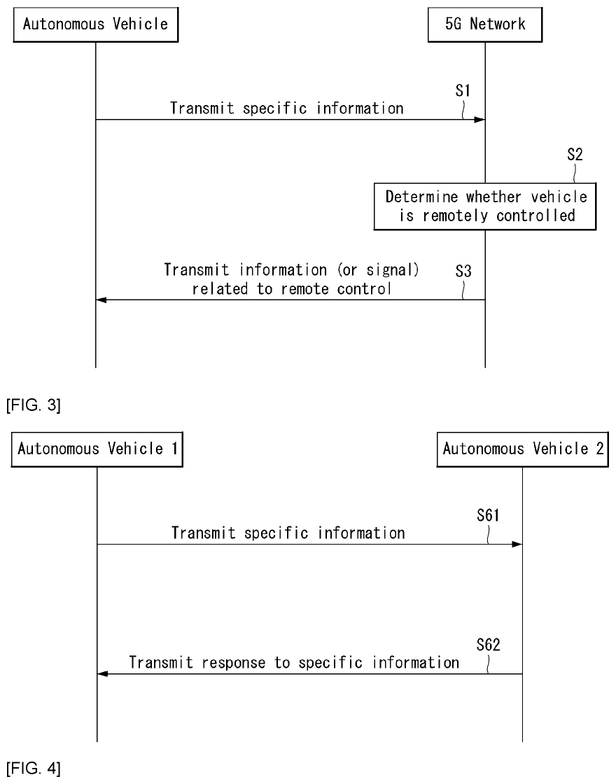

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied operations between autonomous vehicle and 5G network in 5G communication system

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

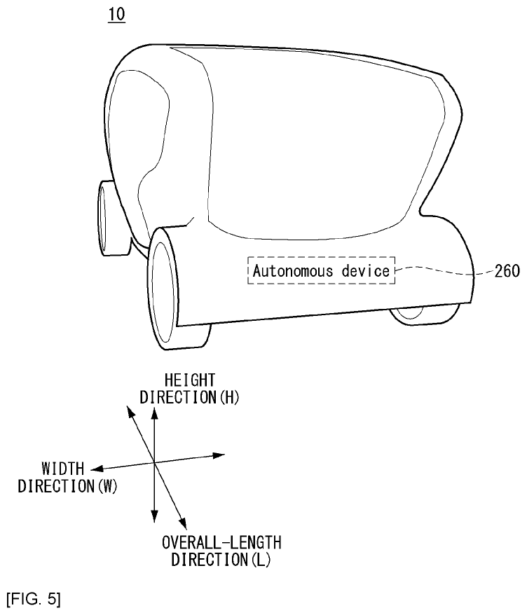

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

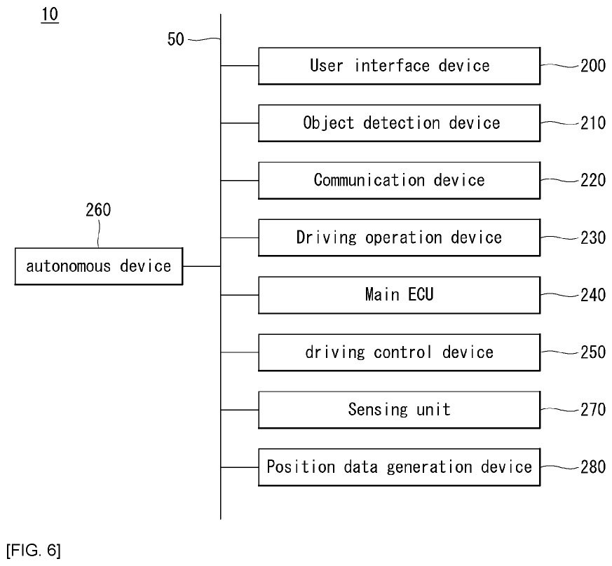

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

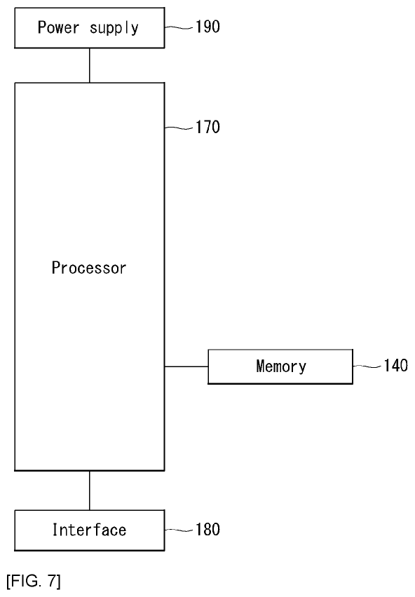

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

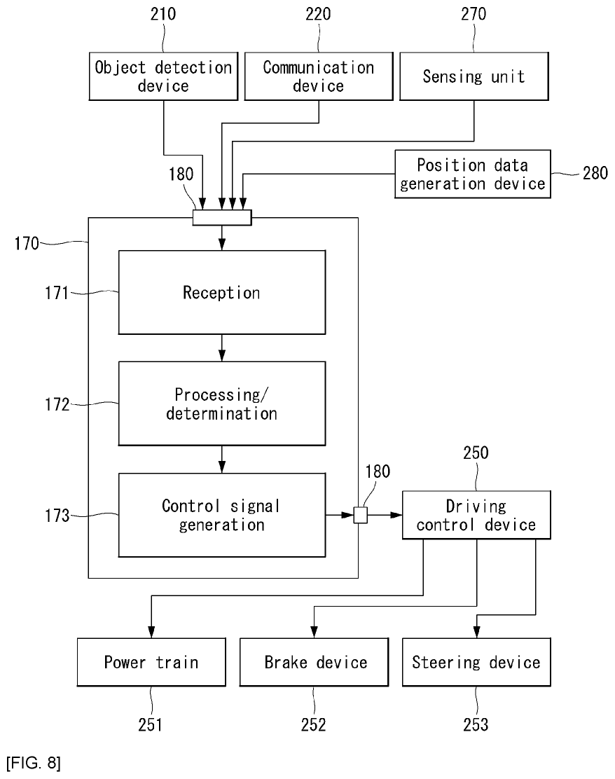

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

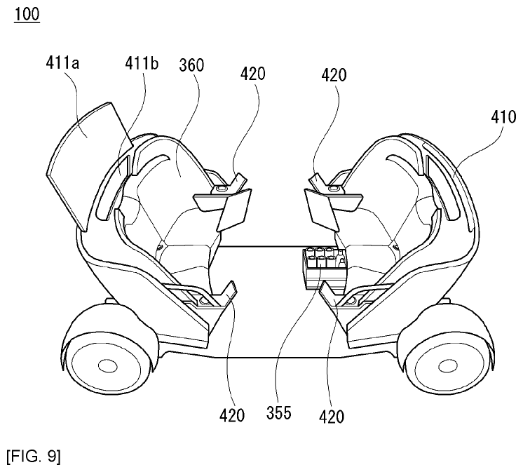

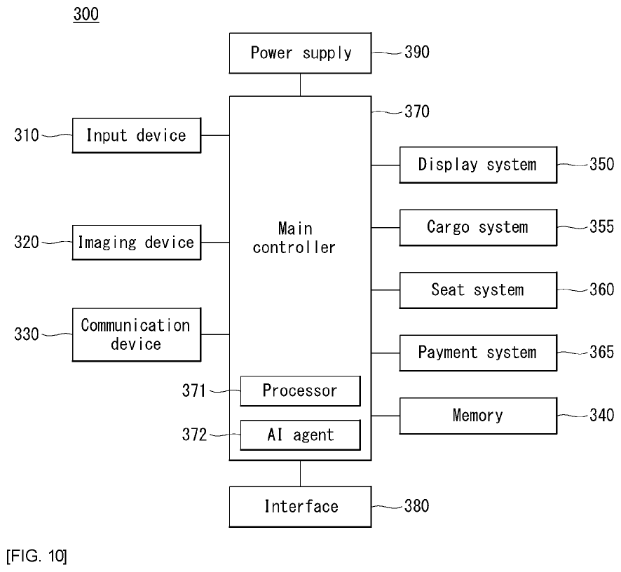

FIG. 9 is a diagram showing the interior of the vehicle according to an embodiment of the present disclosure. FIG. 10 is a block diagram referred to in description of a cabin system for a vehicle according to an embodiment of the present disclosure.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

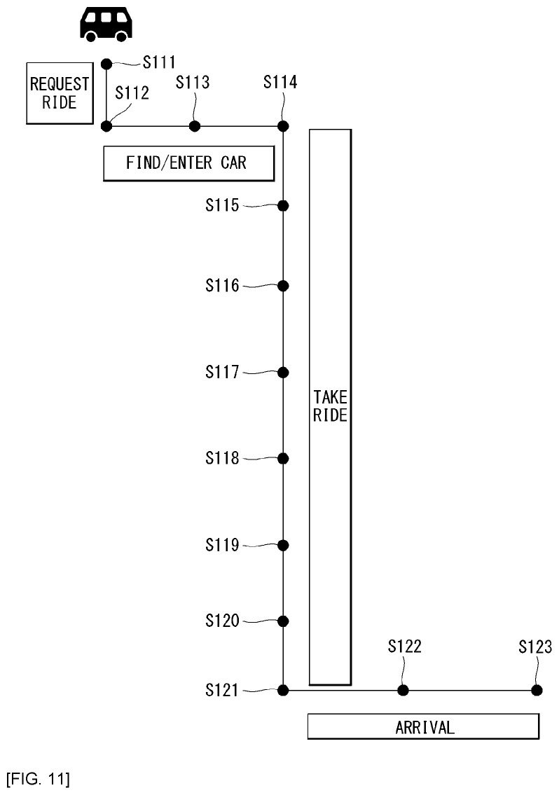

FIG. 11 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present disclosure which will be described later and applied or can complement the methods proposed in the present disclosure to make technical features of the present disclosure concrete and clear.

The present disclosure proposes a technology for minimizing use of resources of a vehicle and overcoming a limit on vehicle performance to process data through P2P between vehicles when network delay occurs.

Hereinafter, various embodiments of the present disclosure will be described in detail with reference to the attached drawings.

MEC Server

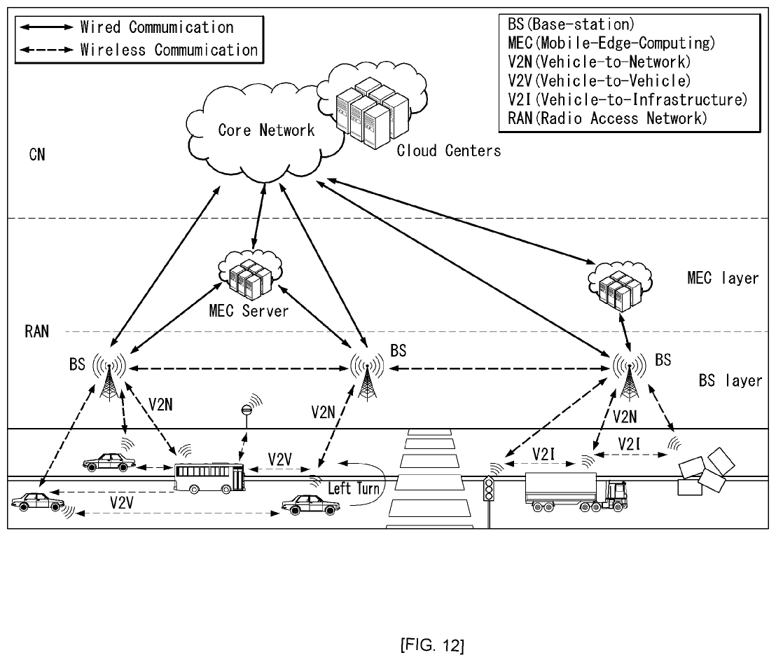

FIG. 12 illustrates an architecture of a mobile edge computing (MEC) server applicable to the present disclosure.

The MEC server not only can perform a role of a normal server but also can provide flexible vehicle related services and allow efficient network operation by being connected to a base station (BS) near a road in a radio access network (RAN). Particularly, a network-slicing and traffic scheduling policy supported by the MEC server can aid in network optimization.

In the architecture, MEC servers may be integrated in the RAN and located at an SI-user plane interface (for example, between a core network and a BS) in a 3GPP system. Each MEC server can be regarded as an independent network element and does not affect connection of existing wireless networks. An independent MEC server is connected to a BS through a dedicated communication network and can provide specific services to various end-users located in the corresponding cell. Such an MEC server and a cloud server are connected through Internet-backbone and can share information. Although the Internet-backbone is connected in a wired manner in the architecture, the Internet-backbone may be connected in a wireless manner according to a configuration method.

The MEC server is independently operated and can control a plurality of BSs. Particularly, the MEC server performs services for autonomous vehicles, an application operation such as a virtual machine (VM), and an operation at a mobile network edge based on a virtualization platform.

A base station (BS) is connected to MEC servers and a core network to facilitate flexible user traffic scheduling required to execute provided services.

The MEC server and a 3G radio network controller (RNC) are located at similar network levels but the following differences are present therebetween.
Dozens, hundreds or more of BSs can be controlled by the RNC, and transmission delay occurrence increases as the number of configured BSs increases. However, the MEC server directly interacts with less than 10 BSs in general and thus can prevent excessive transmission delay.
In addition, since the MEC server in the architecture provides efficient communication between a BS and the core network and also permits previous communication between BSs and between a BS and the core network, the MEC server can be used in the corresponding network.
When large-capacity user traffic is generated in a specific cell, the MEC server can perform task offloading and cooperation processing on the basis of an interface between neighboring BSs.
The RNC provides only a fixed function for wireless network control, whereas the MEC server has an open operation environment based on software and thus new services of application providers can be easily provided.

The architecture including the MEC server can provide the following advantages.
Service waiting time reduction: A data reciprocating time is reduced and a service provision speed is high because services are performed near end-users.
Flexible service provision: MEC applications and virtual network functions (VNF) provide flexibility and geographical distribution in service environments. Various applications and network functions can be programmed and only a specific user group can be selected or compiling only for the specific user group can be performed using such a virtualization technique. Accordingly, provided services can be applied more closely to user requirements.
Cooperation between BSs: The MEC server has central control capability and can minimize interaction between BSs. This can simplify a process for executing basic functions of a network such as handover between cells. Such a function can be useful in automated vehicle & highway systems having many users.
Minimization of congestion: Terminals on roads periodically generate a large amount of small packets in automated vehicle & highway systems. The MEC server in RNC can reduce the amount of traffic that needs to be transmitted to a core network by performing a specific service and thus decrease processing loads of a cloud in a centralized cloud system and minimize network congestion.
Reduction of operation expenses: The MEC server integrates a network control function and individual services and thus can increase profitability of mobile network operators (MNOs) and facilitates rapid and efficient maintenance and upgrade through installation density adjustment.

In general, a long-distance cargo delivery service requires operations of alighting cargo from a vehicle at an intermediate cargo station, classifying the cargo and loading the classified cargo into other vehicles, and thus additional costs and time are needed.

Since cargo is loaded into a vehicle and dispatched at different times in an initial cargo collecting place, time at which all cargo is loaded into a lorry which travels a long distance may be delayed.

To solve the aforementioned problem, in the present disclosure, an autonomous vehicle for delivering goods, for example, from the American West to the American East can open the side of a cargo compartment and deliver goods to another autonomous vehicle during traveling on a road in a traffic environment in which the autonomous vehicle does not obstruct travel of other vehicles.

In the present disclosure, a target autonomous vehicle indicates a large vehicle to which goods are delivered and a delivery autonomous vehicle indicates a small vehicle which delivers goods to a target autonomous vehicle.

A cloud server calculates movement routes such that movement routes of all autonomous vehicles are minimized in consideration of a travel route of a target autonomous vehicle and locations of delivery autonomous vehicles for delivering goods and notifies each autonomous vehicle of the location of a merging point at which goods are delivered.

An MEC server receives travel information of autonomous vehicles at the merging point and lane information on the merging point, determines an operation for controlling autonomous vehicles and transmits a message for controlling operations of the autonomous vehicles to perform a goods delivery operation.

Accordingly, goods can be delivered between autonomous vehicles without a person or additional power in the present disclosure.

In addition, since autonomous vehicles do not stop for the goods delivery operation, a time taken for cargo loading operation is remarkably reduced.

When the cloud server calculates a movement route of each autonomous vehicle such that the time required is minimized and the MEC server generates a message for controlling the operation of each autonomous vehicle on the basis of the calculated movement route and sends the message to an application of each vehicle, the application of the vehicle controls an electronic control unit (ECU) of the autonomous vehicle, for example, an engine RPM ECU and a wheel ECU. Accordingly, all autonomous vehicles can perform cargo loading operation through minimized movement routes.

Further, the MEC server generates a control command for performing goods loading operation at a merging point before arrival at a delivery destination and transmits the control command to autonomous vehicles. Accordingly, goods can be delivered during travel of autonomous vehicles and thus a delivery time can be reduced.

In the present disclosure, an autonomous vehicle includes a rotary motor and a rotary conveyor belt for rearrangement of goods in a cargo compartment.

The autonomous vehicle schedules a motor which control each conveyor belt by time and arranges goods on the side or a high shelf of the cargo compartment such that the goods are easily delivered in the order of scheduling.

The autonomous vehicle can control arrangement of goods in the cargo compartment in order to receive goods from another autonomous vehicle or deliver goods to another autonomous vehicle during traveling.

A target autonomous vehicle can vacate the cargo compartment in order to receive goods and rearrange positions of goods on the basis of delivery scheduling after the goods are received.

In the present disclosure, a server is connected to a network to transmit/receive data to/from an application of a vehicle through a base station such that an application included in the server can perform operation using the data and includes the MEC server or the cloud server.

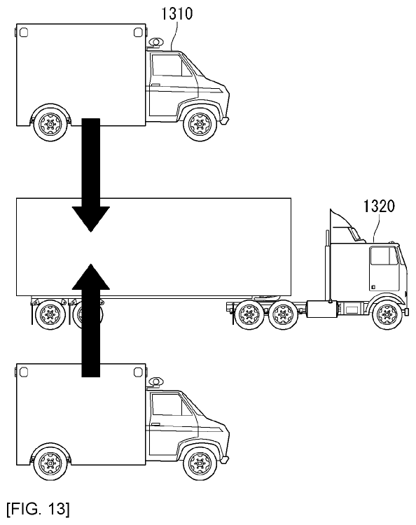

FIG. 13 illustrates an embodiment to which the present disclosure is applicable.

In the present disclosure, autonomous vehicles include a target vehicle 1320 including a lorry and a delivery vehicle 1310 including a small truck capable of delivering goods.

Referring to FIG. 13(a), the cargo compartment of the target vehicle 1320 has doors on the left and right sides thereof such that goods can be received through the doors from the delivery vehicle 1310. In addition, the cargo compartment of the delivery vehicle 1310 also has doors on the sides thereof such that goods can be delivered to the left and right sides of the target vehicle 1320. If only one side of the cargo compartment of the target vehicle 1320 or the delivery vehicle 1310 can be opened, the server can designate a location of the delivery vehicle 1310 in consideration of this. For example, if the cargo compartment of the delivery vehicle 1310 has a door that can open only the left side thereof, a location of the delivery vehicle 1310 can be designated such that the delivery vehicle 1310 can be located on the right of the target vehicle 1320 and the server can request door information of the delivery vehicle 1310.

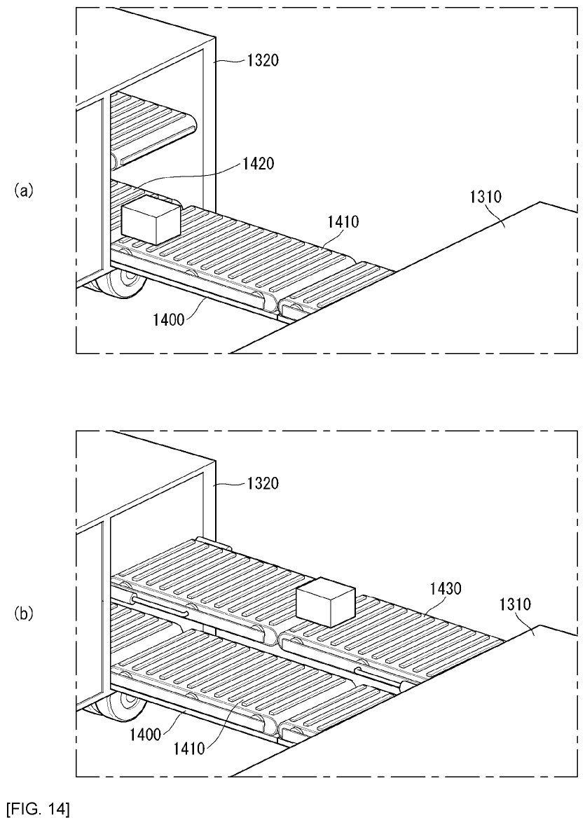

FIG. 14 illustrates an embodiment to which the present disclosure is applicable.

Referring to FIG. 14(a), the delivery vehicle 1310 travels at the same speed as that of the target vehicle 1320 in order to deliver goods to the target vehicle 1320 and controls a travel state such that the positions of doors 1400 are parallel to each other and a distance between the doors 1400 is sufficiently short to deliver goods when the doors 1400 are open. When the traveling speed of the delivery vehicle 1310 becomes equal to that of the target vehicle 1320, the delivery vehicle 1310 and the target vehicle 1320 open the doors 1400. The doors 1400 have a door conveyor belt 1410 positioned therein, and the door conveyor belt 1410 is disposed close to a lower conveyor belt 1420 such that goods can be delivered from the lower conveyor belt 1420 to the door conveyor belt 1410 or delivered from the door conveyor belt 1410 to the lower conveyor belt 1410. The door 1400 is fixed to be parallel to the ground in the open state such that the delivery vehicle 1310 can deliver goods to the lower conveyor belt 1420 of the target vehicle 1320 through the door conveyor belt 1410. Each door 1400 may include a sensor provided at the top thereof for detecting the center of the door and the positions of the doors 1400 of the target vehicle 1320 and the delivery vehicle 1310 can be synchronized through the sensor.

Referring to FIG. 14(b), the delivery vehicle 1310 may deliver goods through an upper conveyor belt 1430. For this, the upper conveyor belt 1430 can be horizontally moved to the outside of the door 1400 and fixed unlike the lower conveyor belt 1420.

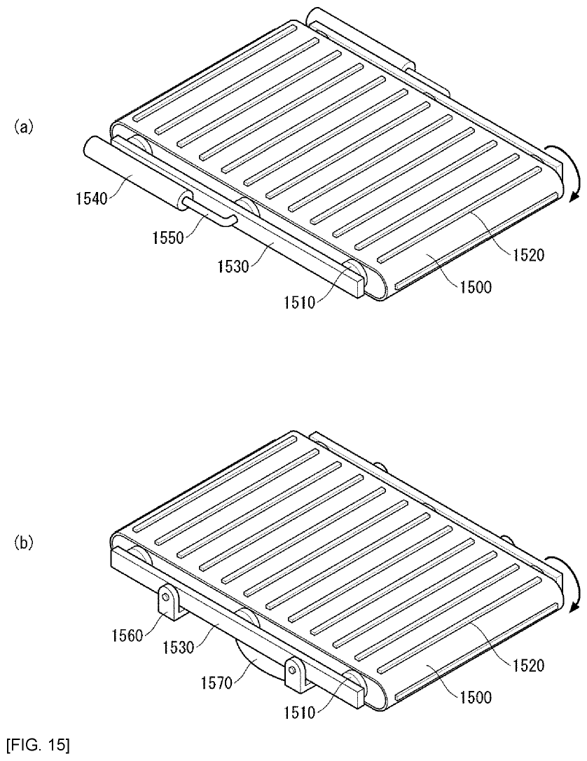

FIG. 15 is a diagram illustrating configurations of conveyor belts to which the present disclosure is applicable. FIG. 15(a) illustrates a configuration of the upper conveyor belt and FIG. 15(b) illustrates a configuration of the lower conveyor belt.

Referring to FIG. 15(a), the upper conveyor belt 1430 includes a belt 1500, a driving motor 1510, stoppers 1520, a guide bar 1530, an air cylinder 1540 and a rod 1550.

The driving motor 1510 moves the belt 1500 through a rotary motion, and the belt 1500 is made of a flexible fabric material and includes the stoppers 1520 provided on the surface thereof which can increase a frictional force by being engaged with fixing grooves 1610 on the upper surface or the lower surface of a cargo box.

The guide bar 1530 is disposed on both sides of the upper conveyor belt 1430 to support the driving motor 1510, and the air cylinder 1540 is combined with the guide bar 1530. The guide bar 1530 is made of a material having sufficient strength such that the shape of the upper conveyor belt 1430 can be maintained in parallel with the ground.

The air cylinder 1540 can adjust the length of the rod 1550 through a piston action, and the rod 1550 is made of a material having sufficient strength for supporting the upper conveyor belt 1430.

For the operation illustrated in FIG. 14(b), the air cylinders 1540 of the delivery vehicle 1310 and the target vehicle 1320 can receive a control signal and operate according thereto through an application of the vehicles and protrude the upper conveyor belt 1430 to the outside of the door 1400 through the piston action. The protruded upper conveyor belt 1430 can be maintained in parallel with the ground surface through the guide bar 1530. The driving motor 1510 moves the belt 1500 through a control signal, and the fixing grooves 1610 at the bottom of the cargo box are engaged with the stoppers 1520 to move along the belt 1500. The cargo box moved to the end of the upper conveyor belt 1430 of the delivery vehicle 1310 comes into contact with the upper conveyor belt 1430 of the target vehicle 1320 and can move to the target vehicle 1320 by being pulled through the stoppers 1520 of the upper conveyor belt 1430 of the target vehicle 1320.

Referring to FIG. 15(b), the lower conveyor belt 1420 does not include the air cylinder 1540 and the rod 1550 from among the components of the upper conveyor belt 1430. However, the lower conveyor belt 1420 includes a support 1560 and a rotary motor 1570 for a rotary motion.

The support 1560 is combined with the guide bar of the lower conveyor belt 1420 and the top of the rotary motor 1570. The lower conveyor belt 1420 can rotate through the rotary motor 1570.

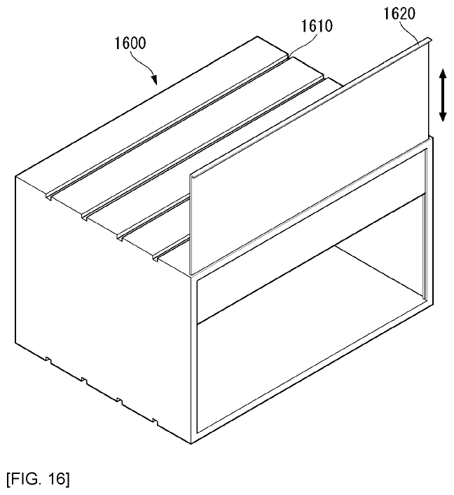

FIG. 16 is a diagram illustrating a configuration of a cargo box to which the present disclosure is applicable.

A cargo box 1600 includes a box door 1620 and the fixing grooves 1610.

A material having high frictional force can be used for the surface of the cargo box 1600 for securing frictional force and the upper surface and the lower surface of the cargo box 1600 include the fixing grooves 1610.

The fixing grooves 1610 can be engaged with the stoppers 1520 to increase frictional force and combined with a robot clipper of vertical transfer apparatus which will be described later.

The box door 1620 can be disposed on the front and rear sides of the cargo box 1600 and vertically moved.

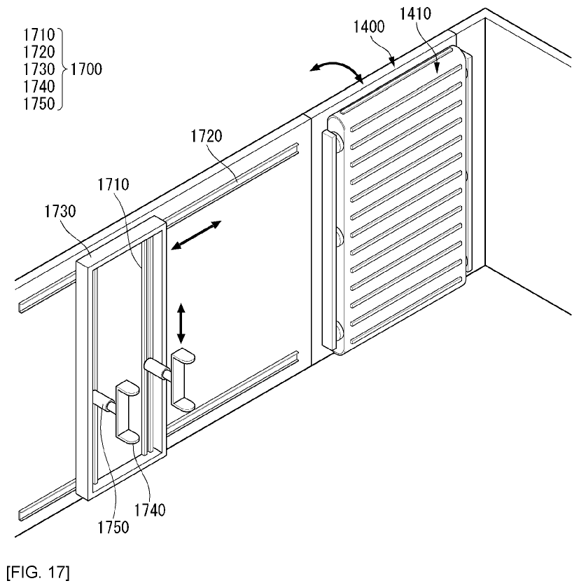

FIG. 17 is a diagram illustrating a configuration of the vertical transfer apparatus to which the present disclosure is applicable.

The vertical transfer apparatus 1700 can be located on the side of the inside of the cargo compartment and includes vertical rails 1710, horizontal rails 1720, a driver 1730, robot clippers 1740 and connectors 1750.

The robot clippers 1740 can clip the upper surface and the lower surface of the cargo box 1600 in order to lift the cargo box 1600 from the belt 1500 and fix the cargo box 1600 through the fixing grooves 1610. The robot clippers 1740 can vertically move the cargo box 1600 and are combined with the vertical rails 1710 through the connectors 1750 for the vertical movement.

The connectors 1750 connect the robot clippers 1740 to the vertical rails 1710. The connector 1750 may include a hydraulic cylinder. Accordingly, the robot clippers 1740 can approach the cargo box 1600. The connectors 1750 can vertically move along the vertical rails 1710 through a motor.

The driver 1730 is combined with the horizontal rails 1720 and located on the side of the inside of the cargo compartment and can horizontally move along the horizontal rails 1720.

The horizontal rails 1720 can be provided on the side of the inside of the cargo compartment in parallel with the floor surface of the cargo compartment. The horizontal rails 1720 do not reach to the area of the door 1400 and are combined with the driver 1730 to cause the driver 1730 to horizontally move.

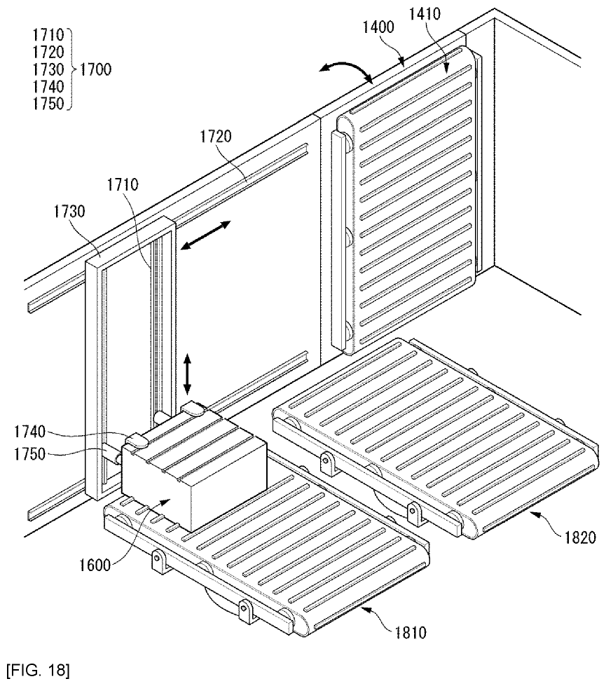

FIG. 18 illustrates an embodiment to which the present disclosure is applicable.

The robot clippers 1740 can be combined with the cargo box 1600 and vertically move along the vertical rails 1710. Further, the driver 1730 can horizontally move the cargo box 1600 along the horizontal rails 1720. Accordingly, the cargo box 1600 can move between a first belt 1500 and a second belt 1500 and between the lower conveyor belt 1420 and the upper conveyor belt 1430. Through this operation, the cargo box 1600 can be placed in front of the door 1400 in a set alighting order.

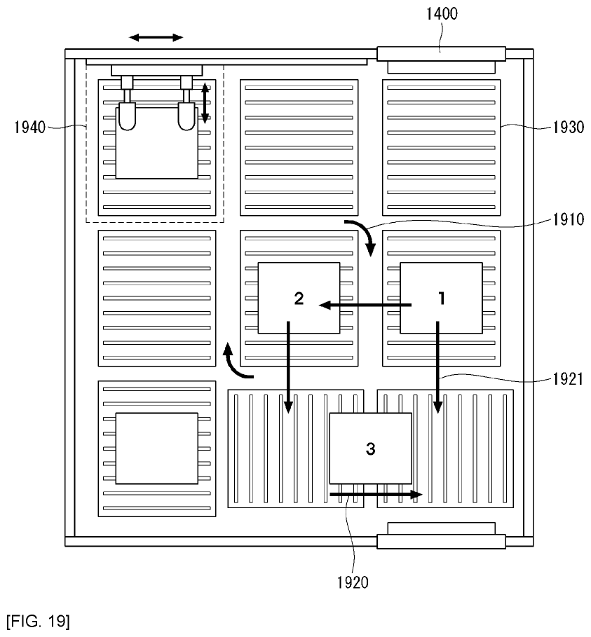

FIG. 19 illustrates the inside of a cargo compartment to which the present disclosure is applicable.

The size and the number of lower conveyor belts 1420 may vary according to types and purposes of goods moved in the cargo compartment. The lower conveyor belt 1420 can rotate (1910) to determine a movement direction of the cargo box 1600.

If the cargo box 1600 needs to be delivered to the target vehicle 1320, the lower conveyor belt 1420 can move the cargo box 1600 to a position close to the door 1400. For example, when cargo box #1 needs to be delivered, it is possible to generate a shortest circular route and move cargo boxes counterclockwise in order to move cargo box #1 to a lower conveyor belt closest to the door 1400 (1920). Accordingly, cargo box #1 can sequentially move to the positions of cargo boxes #2 and #3 to arrive at a position closest to the door 1400. Alternatively, the carbo boxes may be moved clockwise in a similar manner (1921).

When there is a cargo box 1600 that needs to be received from the delivery vehicle 1310, a lower conveyor belt 1930 closest to the door 1400 through which the cargo box 1600 will be received can also be vacated through movement of cargo boxes.

Further, in the case of a double-decked cargo compartment, the cargo box 1600 can be moved between the lower and upper decks through the vertical transfer apparatus 1700. To this end, the upper deck can include a connecting passage 1940 and the vertical transfer apparatus 1700 can vertically move the cargo box 1600 through the connecting passage 1940.

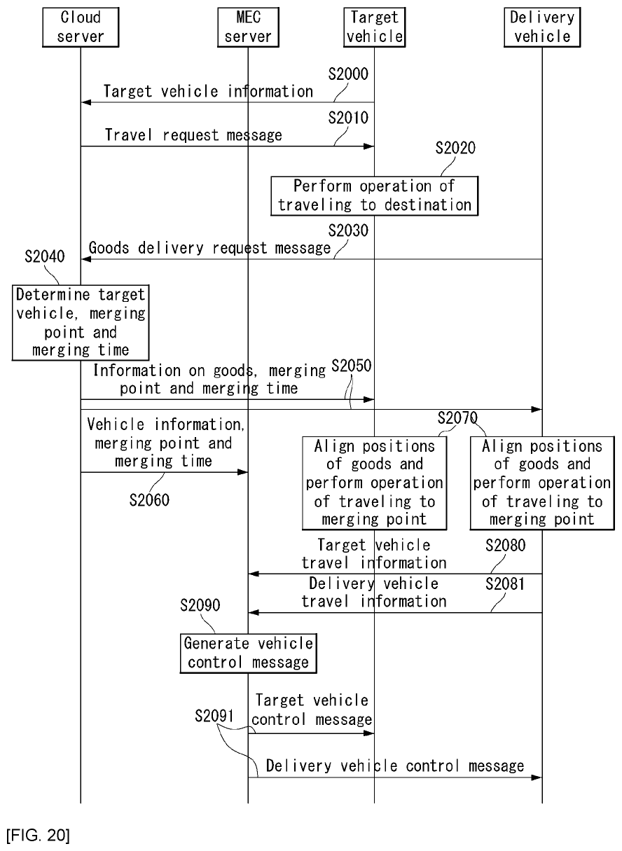

FIG. 20 illustrates an embodiment to which the present disclosure is applicable.

A target vehicle transmits target vehicle information to a cloud server (S2000). The target vehicle information includes specifications of the target vehicle, the number of carrying cargo boxes, positional information of a destination and information on a time of arrival at the destination. The specifications of the target vehicle describe information about the above-described configuration of the cargo compartment.

The cloud server transmits a travel request message to the target vehicle (S2010). The travel request message includes a travel route and an estimated time of arrival of the target vehicle on the basis of the received target vehicle information.

The target vehicle performs an operation of traveling to the destination on the basis of the received travel request message (S2020).

A delivery vehicle transmits a goods delivery request message to the cloud server when there are goods to be delivered (S2030). The goods delivery request message includes specifications of the delivery vehicle, information on the goods to be delivered and positional information of the delivery vehicle.

The cloud server determines the target vehicle on the basis of the target vehicle information and determines a merging point and a merging time depending on the travel route of the target vehicle (S2040). The merging point refers to a road having a traffic environment in which the target vehicle can receive the goods from the delivery vehicle during traveling. To determine the merging point, the cloud server can use traffic information and map information. The merging time refers to a time at which the target vehicle meets the delivery vehicle at the merging point and can be determined on the positional information of the target vehicle and the delivery vehicle and the estimated time of arrival of the target vehicle within a range in which the estimated time of arrival of the target vehicle is not delayed. If there is no appropriate merging point on the initial travel route of the target vehicle, the cloud server can determine a merging point other than the route of the target vehicle within a range in which the estimated time of arrival of the target vehicle is not delayed.

The cloud server transmits information on goods to be delivered, the merging point and the merging time to the target vehicle and the delivery vehicle (S2050). The information on the goods includes IDs and the number of cargo boxes to be delivered.

The cloud server transmits information on the target vehicle and the delivery vehicle, the merging point and the merging time to an MEC server connectable to vehicles at the merging point (S2060).

The target vehicle and the delivery vehicle align positions of goods in cargo compartments thereof on the basis of the information on the goods and perform operation of traveling to the merging point on the basis of the merging point and the merging time (S2070).

The target vehicle arrived at the merging point is connected to the MEC server and transmits travel information of the target vehicle to the MEC server (S2080).

The delivery vehicle arrived at the merging point is connected to the MEC server and transmits travel information of the delivery vehicle to the MEC server (S2081).

The MEC server generates a control message for delivering the goods from the delivery vehicle to the target vehicle at the merging point on the basis of the received travel information (S2090). The control message includes information on lanes in which the target vehicle and the delivery vehicle are traveling and information on a delivery operation start point and time.

The MEC server transmits the generated control message to the target vehicle and the delivery vehicle (S2091).

The target vehicle and the delivery vehicle can perform a goods delivery operation using the received control message.

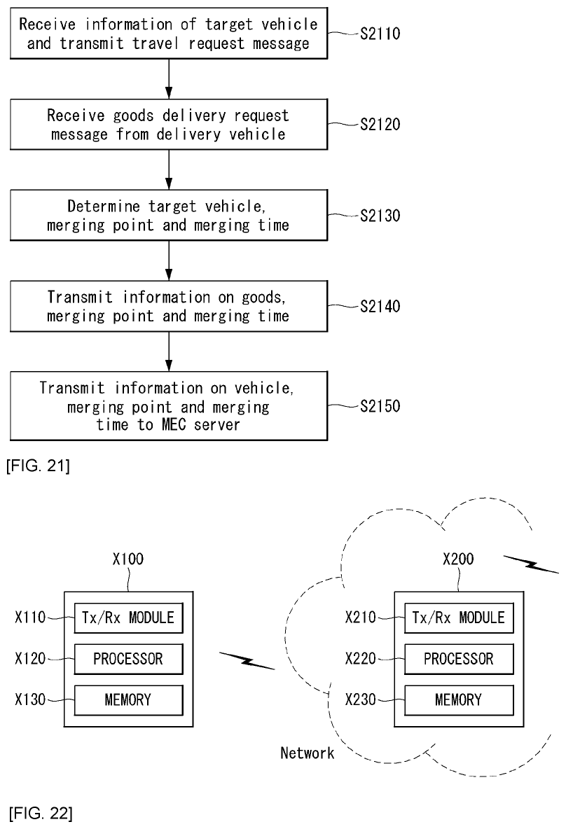

FIG. 21 illustrates an embodiment of a cloud server to which the present disclosure is applicable.

The cloud server receives information on a target vehicle, sets a travel route on the basis of the received information on the target vehicle and transmits a travel request message for requesting travel through the travel route (S2110). The cloud server can manage information on one or more target vehicles.

The cloud server receives, from a delivery vehicle, a goods delivery request message indicating that goods need to be delivered (S2120).

The cloud server determines an appropriate target vehicle on the basis of information on target vehicles managed thereby and determines a merging point and a merging time at which the corresponding target vehicle will meet the delivery vehicle (S2130).

The cloud server transmits information on goods to be delivered, the merging point and the merging time to the target vehicle and the delivery vehicle (S2140).

Further, the cloud server transmits information on the target vehicle and the delivery vehicle, the merging point and the merging time to an MEC server connectable to the target vehicle and the delivery vehicle (S2150).

Accordingly, the cloud server can set the target vehicle such that the target vehicle can receive the goods from the delivery vehicle within an estimated time of arrival at a destination.

Apparatus to which the Present Disclosure is Applicable

Referring to FIG. 22, a server X200 according to a proposed embodiment may be an MEC server or a cloud server and may include a communication module X210, a processor X220 and a memory X230. The communication module X210 may also be referred to as a radio frequency (RF) unit. The communication module X210 can be configured to transmit various signals, data and information to external devices and to receive various signals, data and information from external devices. The server X200 can be connected to external devices in a wired and/or wireless manner. The communication module X210 may be separated into a transmitter and a receiver. The processor X220 can control overall operation of the server X200 and can be configured to execute a function of processing information transmitted/received by the server X200 to/from external devices. Further, the processor X220 can be configured to perform a server operation proposed in the present disclosure. The processor X220 can control the communication module X210 to transmit data or messages to a UE, other vehicles and other servers according to proposition of the present disclosure. The memory X230 can store processed information for a predetermined time and may be replaced by a component such as a buffer.

Furthermore, detailed configurations of a terminal device X100 and the server X200 described above can be implemented such that the above-described various embodiments of the present disclosure are independently applied or two or more thereof are simultaneously applied, and redundant description is omitted for clarity.

### EMBODIMENTS TO WHICH PRESENT DISCLOSURE IS APPLICABLE

### Embodiment 1

A method for delivering goods by a server in an autonomous driving system, the method includes:

receiving information on a target vehicle from the target vehicle; transmitting a travel request message to the target vehicle on the basis of the information on the target vehicle; receiving, from a delivery vehicle, a goods delivery request message for delivering goods to the target vehicle; determining a merging point indicating a point at which the goods will be delivered and a merging time indicating a time at which the delivery vehicle will meet the target vehicle at the merging point; and transmitting information on the goods, the merging point and the merging time to the target vehicle and the delivery vehicle,

wherein goods delivery is performed during traveling of the target vehicle and the delivery vehicle, the travel request message includes a travel route of the target vehicle, and the merging point indicates a point on the travel route which satisfies a road environment in which goods delivery can be performed.

### Embodiment 2

In embodiment 1,

the method further includes transmitting, to a mobile edge computing (MEC) server, information on the target vehicle and the delivery vehicle and information on the merging point and the merging time,

wherein the MEC server is associated with the merging point.

### Embodiment 3

In embodiment 2,

the MEC server generates a control message for causing the target vehicle and the delivery vehicle to perform goods delivery.

### Embodiment 4

In embodiment 1,

the information on the target vehicle includes specifications of the target vehicle, the number of carrying cargo boxes, positional information of a destination, and a time of arrival at the destination.

### Embodiment 5

In embodiment 4,

the method further includes determining the target vehicle on the basis of the information on the target vehicle, wherein the server receives information on one or more target vehicles and the delivery vehicle can deliver the goods to the target vehicle within the time or arrival.

### Embodiment 6

In embodiment 3,

the target vehicle and the delivery vehicle receive the control message for performing goods delivery through the MEC server.

### Embodiment 7

In embodiment 1,

the information on the goods includes IDs and the number of cargo boxes which are targets of goods delivery.

### Embodiment 8

In embodiment 7,

each of the target vehicle and the delivery vehicle includes a cargo compartment for carrying the cargo boxes, the cargo compartment includes a conveyor belt for moving the cargo boxes and a door, and the door connects the target vehicle to the delivery vehicle such that the cargo boxes are delivered.

### Embodiment 9

In embodiment 8,

the target vehicle and the delivery vehicle change positions of the cargo boxes to perform goods delivery through the conveyor belt on the basis of the information on the goods.

### Embodiment 10

In embodiment 8,

the cargo compartment includes one or more decks for carrying the cargo boxes and a vertical transfer apparatus for moving the cargo boxes to the decks, and positions of the cargo boxes can be changed through the vertical transfer apparatus to perform goods delivery.

### Embodiment 11

A first vehicle for delivering goods in an autonomous driving system includes:

a control device for controlling the vehicle; and a cargo compartment for carrying cargo boxes,

wherein the cargo compartment includes a door and a lower conveyor belt for moving the cargo boxes, and the door includes a door conveyor belt for delivering the cargo boxes from the first vehicle to a second vehicle or receiving cargo boxes from the second vehicle during traveling.

### Embodiment 12

In embodiment 11,

the lower conveyor belt includes a rotary motor for rotating the lower conveyor belt, and can change a movement direction of the cargo boxes.

### Embodiment 13

In embodiment 12,

the cargo compartment includes one or more decks for carrying the cargo boxes and a vertical transfer apparatus for moving the cargo boxes to the decks, and the cargo boxes can be vertically moved through the vertical transfer apparatus.

### Embodiment 14

In embodiment 11,

the control device receives positional information on a merging point indicating a point for goods delivery from a server, and goods delivery is performed at the merging point.

### Embodiment 15

In embodiment 14,

the control device receives a control signal for performing goods delivery at the merging point from a mobile edge computing (MEC) server and controls the first vehicle using the control signal, and the MEC server is associated with the merging point.

### Embodiment 16

A server performing a method for delivering goods in an autonomous driving system includes:

a communication module; a memory; and a processor,

wherein the processor receives information on a target vehicle from the target vehicle through the communication module, transmits a travel request message to the target vehicle on the basis of the information on the target vehicle, receives, from a delivery vehicle, a goods delivery request message for delivering goods to the target vehicle, determines a merging point indicating a point at which the goods will be delivered and a merging time indicating a time at which the delivery vehicle will meet the target vehicle at the merging point and transmits information on the goods, the merging point and the merging time to the target vehicle and the delivery vehicle,

wherein goods delivery is performed during traveling of the target vehicle and the delivery vehicle, the travel request message includes a travel route of the target vehicle, and the merging point indicates a point on the travel route which satisfies a road environment in which goods delivery can be performed.

### Embodiment 17

In embodiment 16,

the processor transmits, to a mobile edge computing (MEC) server, information on the target vehicle and the delivery vehicle and information on the merging point and the merging time,

wherein the MEC server is associated with the merging point.

### Embodiment 18

In embodiment 17,

the MEC server generates a control message for causing the target vehicle and the delivery vehicle to perform goods delivery.

### Embodiment 19

In embodiment 16,

the information on the target vehicle includes specifications of the target vehicle, the number of carrying cargo boxes, positional information of a destination, and a time of arrival at the destination.

### Embodiment 20

In embodiment 19,

the processor determines the target vehicle on the basis of the information on the target vehicle, and

receives information on one or more target vehicles through the communication module, and the delivery vehicle can deliver the goods to the target vehicle within the time or arrival.

### Embodiment 21

In embodiment 18,

the target vehicle and the delivery vehicle receive the control method for performing goods delivery through the MEC server.

### Embodiment 22

In embodiment 16,

the information on the goods includes IDs and the number of cargo boxes which are targets of goods delivery.

### Embodiment 23

In embodiment 22,

each of the target vehicle and the delivery vehicle includes a cargo compartment for carrying the cargo boxes, the cargo compartment includes a conveyor belt for moving the cargo boxes and a door, and the door connects the target vehicle to the delivery vehicle such that the cargo boxes are delivered.

### Embodiment 24

In embodiment 23,

the target vehicle and the delivery vehicle change positions of the cargo boxes to perform goods delivery through the conveyor belt on the basis of the information on the goods.

### Embodiment 25

In embodiment 23,

the cargo compartment includes one or more decks for carrying the cargo boxes and a vertical transfer apparatus for moving the cargo boxes to the decks, and positions of the cargo boxes can be changed through the vertical transfer apparatus to perform goods delivery.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present disclosure without departing from the spirit or scope of the invention described in the appended claims. For example, each component described in detail in embodiments can be modified. In addition, differences related to such modifications and applications should be interpreted as being included in the scope of the present disclosure defined by the appended claims.

What is claimed is:

1. A method for delivering goods by a server in an autonomous driving system, the method comprising:
receiving information on a target vehicle from the target vehicle;
transmitting a travel request message to the target vehicle on the basis of the information on the target vehicle;
receiving, from a delivery vehicle, a goods delivery request message for delivering goods to the target vehicle;
determining a merging point indicating a point at which the goods will be delivered and a merging time indicating a time at which the delivery vehicle will meet the target vehicle at the merging point; and
transmitting information on the goods, the merging point and the merging time to the target vehicle and the delivery vehicle,
wherein goods delivery is performed during traveling of the target vehicle and the delivery vehicle, the travel request message includes a travel route of the target vehicle, and the merging point indicates a point on the travel route which satisfies a road environment in which goods delivery can be performed.

2. The method of claim 1, further comprising transmitting, to a mobile edge computing (MEC) server, information on the target vehicle and the delivery vehicle and information on the merging point and the merging time,
wherein the MEC server is associated with the merging point.

3. The method of claim 2, wherein the MEC server generates a control message for causing the target vehicle and the delivery vehicle to perform goods delivery.

4. The method of claim 1, wherein the information on the target vehicle includes specifications of the target vehicle, the number of carrying cargo boxes, positional information of a destination, and a time of arrival at the destination.

5. The method of claim 4, further comprising determining the target vehicle on the basis of the information on the target vehicle,
wherein the server receives information on one or more target vehicles and the delivery vehicle delivers the goods to the target vehicle within the time or arrival.

6. The method of claim 3, wherein the target vehicle and the delivery vehicle receive the control message for performing goods delivery through the MEC server.

7. The method of claim 1, wherein the information on the goods includes IDs and the number of cargo boxes which are targets of goods delivery.

8. The method of claim 7, wherein each of the target vehicle and the delivery vehicle includes a cargo compartment for carrying the cargo boxes,
wherein the cargo compartment includes a conveyor belt for moving the cargo boxes and a door, and the door connects the target vehicle to the delivery vehicle such that the cargo boxes are delivered.

9. The method of claim 8, wherein the target vehicle and the delivery vehicle change positions of the cargo boxes to perform goods delivery through the conveyor belt on the basis of the information on the goods.

10. The method of claim 8, wherein the cargo compartment includes one or more decks for carrying the cargo boxes and a vertical transfer apparatus for moving the cargo boxes to the decks, and positions of the cargo boxes are changed through the vertical transfer apparatus to perform goods delivery.

11. A first vehicle for delivering goods in an autonomous driving system, the first vehicle comprising:
a control device for controlling the vehicle; and
a cargo compartment for carrying cargo boxes,
wherein the cargo compartment includes a door and a lower conveyor belt for moving the cargo boxes, and the door includes a door conveyor belt for delivering the cargo boxes from the first vehicle to a second vehicle or receiving cargo boxes from the second vehicle during traveling.

12. The first vehicle of claim 11, wherein the lower conveyor belt includes a rotary motor for rotating the lower conveyor belt and changes a movement direction of the cargo boxes.

13. The first vehicle of claim 12, wherein the cargo compartment includes one or more decks for carrying the cargo boxes and a vertical transfer apparatus for moving the cargo boxes to the decks, and the cargo boxes are vertically moved through the vertical transfer apparatus.

14. The first vehicle of claim 11, wherein the control device receives positional information on a merging point indicating a point for goods delivery from a server, and goods delivery is performed at the merging point.

15. The first vehicle of claim 14, wherein the control device receives a control signal for performing goods delivery at the merging point from a mobile edge computing (MEC) server and controls the first vehicle using the control signal, and the MEC server is associated with the merging point.

16. A server performing a method for delivering goods in an autonomous driving system, the server comprising:
a transceiver;
a memory; and
a processor,
wherein the processor is configured:
to receive information on a target vehicle from the target vehicle through the transceiver; to transmit a travel request message to the target vehicle on the basis of the information on the target vehicle; to receive, from a delivery vehicle, a goods delivery request message for delivering goods to the target vehicle; to determine a merging point indicating a point at which the goods will be delivered and a merging time indicating a time at which the delivery vehicle will meet the target vehicle at the merging point; and to transmit information on the goods, the merging point and the merging time to the target vehicle and the delivery vehicle,
wherein goods delivery is performed during traveling of the target vehicle and the delivery vehicle, the travel request message includes a travel route of the target vehicle, and the merging point indicates a point on the travel route which satisfies a road environment in which goods delivery can be performed.

17. The server of claim 16, wherein the processor is configured to transmit, to a mobile edge computing (MEC) server, information on the target vehicle and the delivery vehicle and information on the merging point and the merging time,
wherein the MEC server is associated with the merging point.

18. The server of claim 17, wherein the MEC server generates a control message for causing the target vehicle and the delivery vehicle to perform goods delivery.

19. The server of claim 16, wherein the information on the target vehicle includes specifications of the target vehicle, the number of carrying cargo boxes, positional information of a destination, and a time of arrival at the destination.

20. The server of claim 19, wherein the processor is configured to determine the target vehicle on the basis of the information on the target vehicle, to receive information on one or more target vehicles through the transceiver, and the delivery vehicle delivers the goods to the target vehicle within the time or arrival.
